(19) United States
(12) Patent Application Publication
(10) Pub. No.: US 2017/0267056 A1
(43) Pub. Date: Sep. 21, 2017

(54) CONTROL METHOD OF BATTERY COOLING SYSTEM FOR VEHICLE

(71) Applicants: Hyundai Motor Company, Seoul (KR); Kia Motors Corporation, Seoul (KR); Hanon Systems, Daejeon (KR)

(72) Inventors: Jae Yeon KIM, Hwaseong-si (KR); Hoseong LEE, Seoul (KR); In Guk HWANG, Daejeon (KR); Yunho HWANG, Ellicott City, MD (US)

(73) Assignees: Hyundai Motor Company, Seoul (KR); Kia Motors Company, Seoul (KR); Hanon Systems, Daejeon (KR)

(21) Appl. No.: 15/288,100

(22) Filed: Oct. 7, 2016

(30) Foreign Application Priority Data
Mar. 17, 2016 (KR) 10-2016-0032345

(51) Int. Cl. B60H 1/00; B60H 1/32; B60L 11/18

(52) U.S. Cl. CPC B60H 1/00278; B60L 11/1874; B60H 1/3205; B60L 2240/545; B60H 2001/00307; B60H 2001/3255; B60H 2001/3285; B60H 2001/3288

(57) ABSTRACT

A control method for a battery cooling system of a vehicle which is provided for controlling temperature of a battery module by using a refrigerant supplied to a chiller in the battery cooling system may include (A) determining, by a controller, whether an air conditioner is operated, while driving or stopping the vehicle in a state where the vehicle is started, (B) controlling, by the controller, a first expansion valve, and detecting, by the controller, the temperature of the battery module when the controller determines that the air conditioner is operated, and (C) determining, by the controller, selective operation of a second expansion valve through determining whether the temperature of the battery module, which is detected through the controlling in (B), is within a predetermined range.

### CROSS-REFERENCE TO RELATED APPLICATION

The present application claims priority to Korean Patent Application No. 10-2016-0032345, filed Mar. 17, 2016, the entire contents of which is incorporated herein for all purposes by this reference.

### BACKGROUND OF THE INVENTION

Field of the Invention

Various aspects of the present invention relate to a control method of a battery cooling system for a vehicle. More particularly, to a control method of a battery cooling system for a vehicle, which interlocks an air conditioning means and an electric cooling means in an electric vehicle or a hybrid vehicle and cools down a battery module using cooling water which is heat exchanged with the refrigerant.

Description of Related Art

In general, an air conditioning system for a vehicle includes an air conditioning system that circulates a refrigerant to warm up or cool down the interior of the vehicle.

Such an air conditioning means can maintain a comfortable indoor environment of the vehicle by maintaining a vehicle indoor temperature at an appropriate temperature regardless of a temperature change of the outside, and the refrigerant discharged by driving of a compressor circulates back to the compressor through a condenser, a receiver dryer, an expansion valve, and an evaporator and heat exchange occurs during the circulation such that the interior of the vehicle is warmed up or cooled down.

That is, in a summer cooling mode, a high-temperature and high-pressure gaseous refrigerant compressed by the compressor is condensed through the condenser and then evaporated through the receiver dryer and the expansion valve such that the indoor temperature and humidity of the vehicle can be lowered.

Recently, there has been a need for developing an environmentally-friendly vehicle that can substantially replace the Internal Combustion Engine (ICE) vehicles, with an increasing concern on energy efficiency and the problem with environmental pollution and the environmentally-friendly vehicle generally falls into the categories of an electric vehicle driven by a fuel cell or electricity as the power source, and a hybrid vehicle driven by an engine and an electric battery.

In the electric vehicle, among the environmentally-friendly vehicles, a separate heater is not used unlike an air conditioner of a general vehicle, and an air conditioner, which is applied to the electric vehicle, is typically referred to as a heat pump system.

In the case of the electric vehicle, chemical reaction energy of oxygen and hydrogen is converted into electric energy to generate driving force, and during this process, heat energy is generated by chemical reaction in the fuel cell, and as a result, effectively removing generated heat is required to secure performance of the fuel cell.

Even in the hybrid vehicle, the driving force is generated by driving the motor by using electricity supplied from the fuel cell or the electric battery together with the engine that is actuated with general fuel, and as a result, the performance of the motor can be secured only by effectively removing the heat generated from the fuel cell or the battery, and the motor.

Accordingly, a conventional hybrid vehicle or a conventional electric vehicle needs to be provided with an electric cooling means, a heat pump system, and a battery cooling system, respectively formed as closed circuits, to prevent overheating of a battery including a motor, an electric unit, and a fuel cell.

Thus, the size and weight of a cooling module provided in a front side of the vehicle are increased, and a layout of a connection pipe through which a refrigerant or cooling water is supplied to the heat pump system, the electric cooling means, and the battery cooling system respectively in an engine room becomes complicated.

Further, since the battery cooling system that warms up or cools down the battery according to a state of the vehicle for optimal performance of the battery is separately provided, a plurality of valves are required to connect the battery cooling system to the respective connection pipes and noise and vibration generated from frequent closing and opening of the valves are transferred to the interior of the vehicle, thereby deteriorating riding comfort.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a control method of a battery cooling system for a vehicle, which can selectively use a refrigerant and cooling water that circulate an air conditioning means and an electric cooling means in an electric vehicle or a hybrid vehicle to cool down a battery module in a water-cooling manner to thereby increase a total travel distance of the vehicle through effective battery management.

According to various aspects of the present invention, a control method for a battery cooling system of a vehicle which is provided for controlling temperature of a battery module by using a refrigerant supplied to a chiller in the battery cooling system, the battery cooling system including an air conditioner connected through a refrigerant line and a circulating refrigerant, an electric cooler connected with a cooling line and circulating a coolant, the battery module connected with the electric cooler through a battery cooling line, and the chiller supplying the coolant heat-exchanged with the refrigerant to the battery module, may include (A) determining, by a controller, whether the air conditioner is operated, while driving or stopping the vehicle in a state where the vehicle is started, (B) controlling, by the controller, a first expansion valve, and detecting, by the controller, the temperature of the battery module when the controller determines that the air conditioner is operated, and (C) determining, by the controller, selective operation of a second expansion valve through determining whether the temperature of the battery module, which is detected through the controlling in (B), is within a predetermined range.

The determining in (A) may include driving or stopping the vehicle in a state where the vehicle is started, and determining, by the controller, whether the air conditioner is operated.

The controlling in (B) may include operating, by the controller, the first expansion valve when the controller determines that the air conditioner is operated through the determining in (A), operating, by the controller, a cooling fan and a compressor in a state that the first expansion valve is operated, and detecting, by the controller, the temperature of the battery module.

The method may further include detecting, by the controller, the temperature of the battery module when the controller determines that the air conditioner is not operated, in the determining in (A).

The determining in (C) may include determining, by the controller, whether the temperature of the battery module, which is detected through the controlling in (B), is within predetermined set values, and operating, by the controller, the second expansion valve to inflow the expanded refrigerant to the chiller when the controller determines that the temperature of the battery module is not within the predetermined set values.

The second expansion valve may be disposed on a first connection line which connects the chiller and the refrigerant line.

The chiller may be connected to the battery cooling line through a second connection line.

The first expansion valve and the second expansion valve may be selectively operated according to a control signal of a full auto air condition temperature controller (FATC).

The controller may include the FATC, an electric power control unit (EPCU), and a battery management control unit (BMCU) which are connected using Controller Area Network (CAN) communication with each other, and the EPCU may control an operation of a cooling fan, the BMCU may detect the temperature of the battery module, and the FATC may selectively operate the second expansion valve by a signal, which is output from the BMCU, for requiring operation of the second expansion valve.

The electric cooler may include an electric radiator and a first water pump connected with a cooling line, and circulating cooling water to cool a motor, the EPCU, and an on board charger.

A second water pump may be disposed on the battery cooling line between the battery module and the chiller, and may be operated by the BMCU.

The determining in (C) may include operating, by the controller, the second water pump after the operating, by the controller, of the second expansion valve.

The battery cooling line may include a first valve connecting the cooling line that connects the motor and the electric device, and the battery cooling line, and a second valve connecting the cooling line, the battery cooling line, and the second connection line.

The second valve may close the cooling line and connect the battery cooling line and the second connection line when cooling the battery module using a refrigerant.

As described above, the control method of the battery cooling system for the vehicle according to various embodiments of the present invention may selectively use a refrigerant and cooling water circulating an air conditioner and an electric cooler in an electric vehicle or a hybrid vehicle to cool down a battery module in a water-cooling manner so that the system can be simplified, and the total travel distance of the vehicle can be increased through effective battery management.

Further, as the controller controls an operation of an expansion valve which is connected to the chiller when the battery module needs to be cooled, cooling efficiency can be improved by further decreasing a temperature of the cooling water which is flowed into the battery module.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a battery cooling system for a vehicle applied to a controlling method of a battery cooling system for a vehicle according to various embodiments of the present invention.

FIG. 2 is a control flowchart to explain a control method of a battery cooling system for a vehicle according to various embodiments of the present invention.

FIG. 3 is a diagram illustrating a control of an expansion valve and a water pump by the control method of a battery cooling system for a vehicle according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

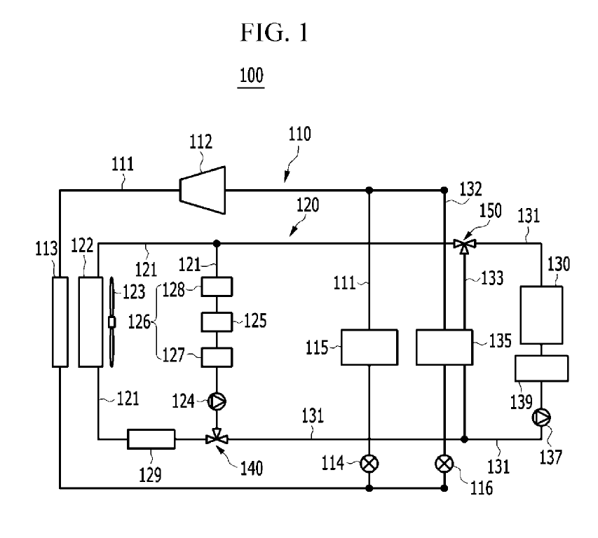

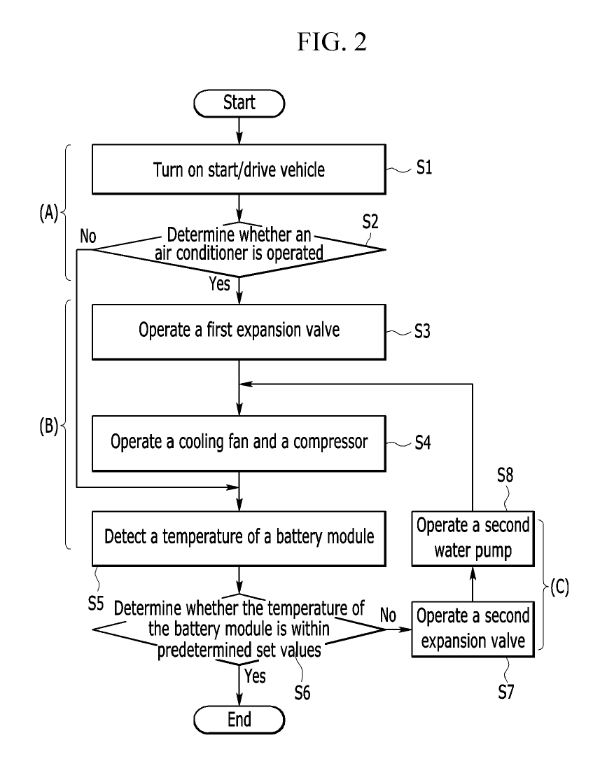

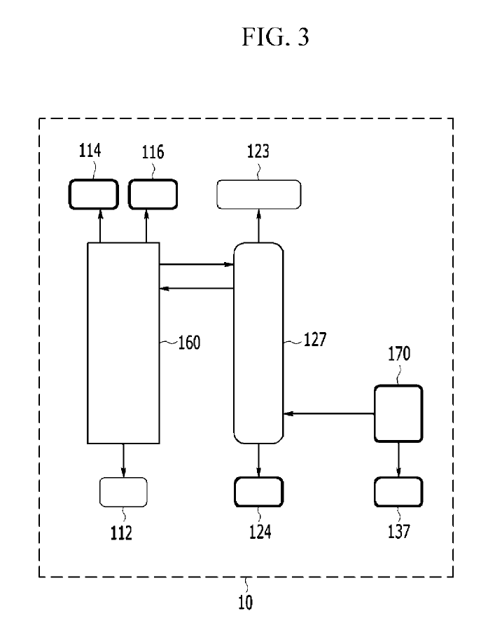

FIG. 1 is a block diagram of a battery cooling system for a vehicle applied to a controlling method of a battery cooling system for a vehicle according to various embodiments of the present invention, FIG. 2 is a control flowchart to explain a control method of a battery cooling system for a vehicle according to various embodiments of the present invention, and FIG. 3 is a diagram illustrating a control of an expansion valve and a water pump by the control method of a battery cooling system for a vehicle according to various embodiments of the present invention.

Referring to FIGS. 1-3, a control method of a battery cooling system for a vehicle according to various embodiments of the present invention is applicable to a hybrid vehicle or an electric vehicle, which also uses an engine and a motor together.

Such a battery cooling system 100 interacts with an air conditioner 110, which is an air conditioner for cooling down or warming up the interior of the vehicle, and an electric cooler 120 cooling down a motor 125 and an electric device 126.

In the present exemplary embodiment, the air conditioner 110 includes a compressor 112, a condenser 113, an evaporator 114, and a first expansion valve 115 that are connected with each other through a refrigerant line 111.

Such an air conditioner 110 cools down the interior of the vehicle through circulation of a refrigerant during a vehicle cooling mode.

The electric cooler 120 includes an electric radiator 122 and a first water pump 124 connected through the cooling line 121, and circulates cooling water to cool the motor 125 and the electric device 126.

Here, the electric device 126 may include an electric power control unit (EPCU) 127 provided on the cooling line 121 between the motor 125 and the first water pump 124 and an on-board charger (OBC) 128 provided on the cooling line 121 between the motor 125 and the electric radiator 122.

The electric radiator 122 is provided in a front side of the vehicle, and a cooling fan 123 is provided in a rear side of the vehicle such that cooling water is cooled by operation with the cooling fan 123 and heat exchange with an outside air.

The electric cooler 120 configured as above circulates the cooling water cooled in the electric radiator 122 through the cooling line 121 by operation of the first water pump 124 so as to cool down the motor 125 and the electric device 126.

Here, the battery cooling system 100 according to various embodiments of the present invention may include a battery module 130, a chiller 135, a second water pump 137, and a heater 139.

The battery module 130 supplies power to the motor 125 and the electric device 126, and is connected with the electric cooler 120 through a battery cooling line 131

Such a battery module 130 may be a water-cooled type and thus is cooled by cooling water.

The chiller 135 is connected with the refrigerant line 111 of the air conditioner 110 through a first connection line 132, is connected with the battery cooling line 131 through a second connection line 133, and controls a temperature of the cooling water by heat-exchanging cooling water and a refrigerant flowing therein.

Here, in the first connection line 132, a second expansion valve 116 may be provided between the condenser 113 and the chiller 135.

The second expansion valve 116 operates when a vehicle cooling mode starts or the battery module 130 is cooled using the refrigerant. Such a second expansion valve 116 expands the refrigerant introduced through the first connection line 132 to introduce the refrigerant in a lower temperature state to the chiller 135.

That is, the second expansion valve 116 expands the condensed refrigerant discharged from the condenser 113 to lower the temperature of the refrigerant and introduces the low-temperature refrigerant to the chiller 135 such that a temperature of the cooling water passing through the inside of the chiller 135 can be further decreased. Accordingly, the cooling water of which the temperature is decreased while passing through the chiller 135 is introduced into the battery module 130 such that the battery module 130 can be more efficiently cooled down.

The second water pump 137 is provided on the battery cooling line 131 between the battery module 130 and the chiller 135.

Such a second water pump 137 circulates the cooling water to the battery cooling line 131.

Here, the first water pump 124 and the second water pump 137 may be electrical water pumps.

The heater 139 is provided on the battery cooling line 131 between the second water pump 137 and the battery module 130.

Here, when the battery module 130 is warmed up, the heater 139 is turned on to heat the cooling water circulating the battery cooling line 131 and introduce the heated cooling water.

In various embodiments, the battery cooling line 130 is provided with a first valve 140 and a second valve 150.

The first valve 140 may connect the cooling line 121 that connects the motor 125 and the electric device 126 and the battery cooling line 131 between the electric radiator 122 and the heater 139.

Such a first valve 140 may connect the electric radiator 122, the cooling line 121 connected to the motor 125 and the electric device 126, and the battery cooling line 131 when cooling the battery module 130 using the cooling water.

In addition, the second valve 150 may connect the cooling line 121, the battery cooling line 131, and the second connection line 133 connected with the chiller 135 between the battery module 130 and the electric radiator 122.

Such a second valve 150 may close the second connection line 133 connected with the chiller 135 when cooling down the battery module 130 using the cooling water.

In addition, the second valve 150 may close the cooling line 121 and connect the battery cooling line 131 and the second connection line 133 when cooling down the battery module 130 using the refrigerant.

The first valve 140 and the second valve 150 may be 3-way valves.

Meanwhile, the cooling line 121 may be provided with a reservoir tank 129 between the electric radiator 122 and the first valve 140.

The reservoir tank 129 may store cooled cooling water introduced from the electric radiator 122.

In various embodiments, the first water pump 124 is provided on the cooling line 121 between the first valve 140 and a power controller 127, but the various embodiments are not limited thereto. The first water pump 124 may be provided on the cooling line 121 between the first valve 140 and the reservoir tank 129.

When the first water pump 124 is provided between the reservoir tank 129 and the first valve 140, the first water pump 124 operates together with the second water pump 137 in case of cooling the battery module 130 with the cooling water such that the flow amount of cooling water circulating the battery module 130 can be increased.

Various embodiments of the present invention are directed to providing a control method of a battery cooling system for a vehicle including (A) determining, by a controller 10, whether the air conditioner 110 is operated, while driving or stopping the vehicle in a state where a start of the vehicle is turned on, (B) controlling, by the controller 10, a first expansion valve 114, and detecting, by the controller 10, the temperature of a battery module 130 when the controller 10 has determined that the air conditioner 110 is operated, and (C) determining, by the controller 10, selective operation of a second expansion valve 116 through determining whether the temperature of a battery module 130, which is detected through the process (B), is within a predetermined range.

Here, processes (A), (B), and (C) may be performed by the controller 10. The controller 10 may be a general electronic control unit (ECU) generally handling the control of electronic devices of the vehicle.

First, in process (A), at step S1, the vehicle is driven or stopped in a state where a start of the vehicle is turned on, and at step S2, the controller 10 determines whether the air conditioner 110 is operated.

When the controller 10 determines that the air conditioner 110 is operated, the controller 10 operates the first expansion valve 114, at step S3.

Thereafter, the controller 10 operates the compressor 112 and the cooling fan 123, at step S4, and detects the temperature of the battery module 130, at step S5.

That is, the air conditioner 110 operates to cool down the interior of the vehicle by circulating the compressed refrigerant by the operation of the compressor 112.

Meanwhile, when the controller 10 determines that the air conditioner 110 is not operated, at step S2, the controller 10 detects the temperature of the battery module 130, at step S5.

Thereafter, the controller 10 determines whether the temperature of the battery module 130, which is detected through the process (B), is within predetermined set values, at step S6.

The controller 10 ends control when the controller 10 determines that the temperature of the battery module 130 is within the predetermined set values.

On the contrary, the controller 10 operates the second expansion valve 113 so as to inflow the expanded refrigerant to the chiller 135 when the controller 10 determines that the temperature of the battery module is not within the predetermined set values (S7).

In this case, the refrigerant is circulated through the refrigerant line 111 by operating the compressor 112, and does not flow into the evaporator 115 as the first expansion valve 114 is not operated. Accordingly, the refrigerant having expanded while passing through the second expansion valve 114 flows into the chiller 135, and is heat-exchanged with the cooling water in the chiller 135.

Here, the controller 10 operates the second water pump 137 such that the cooling water is circulated to the chiller 135 (S8).

Then, the step S4 of operating the compressor 112 and the cooling fan 123 may be performed again, and the above mentioned the steps may be repeatedly performed.

That is, the refrigerant circulates through the refrigerant line 111 so as to cool down the interior of the vehicle when cooling is required to the battery module 130 in a state in which the air conditioner 110 is operated.

In this case, the refrigerant is introduced to the condenser 113 from the compressor 112 and passes through the first expansion valve 114 along the cooling line 121 while being condensed through heat-exchange with the outside air.

The refrigerant having expanded while passing through the first expansion valve 114 is evaporated through the evaporator 115, and then supplied again to the compressor 112 and circulates the air conditioner 110.

Here, the second expansion valve 116 is opened, and partially expands the refrigerant discharged from the condenser 113 and supplies the expanded refrigerant to the chiller 135. Further, the second valve 135 may close the cooling line 121, and may connect the battery cooling line 131 and the second connection line 133.

Then, the cooling water cooled from heat-exchange with the refrigerant in the chiller 135 is introduced into the battery module 130 by operation of the second water pump 137. Accordingly, the cooled cooling water can effectively cool down the battery module 130.

On the contrary, when cooling is required to the battery module 130 in a state that the air conditioner 110 is not operated, the operation of the first expansion valve 114 is stopped such that no more refrigerant is introduced into the evaporator 115.

That is, the refrigerant is introduced into the condenser 113 from the compressor 112 and condensed through heat-exchange with the outside air. After that, the refrigerant is discharged from the condenser 113 and expanded while passing through the second expansion valve 116 along the cooling line 121, and then passed through the chiller 135 and supplied back to the compressor 112.

Here, the second valve 135 may close the cooling line 121 and may connect the battery cooling line 131 and the second connection line 133.

Then, the cooling water cooled from heat-exchange with the refrigerant in the chiller 135 is introduced into the battery module 130 by operation of the second water pump 137. Accordingly, the cooled cooling water can effectively cool down the battery module 130.

As shown FIG. 3, the first expansion valve 114 and the second expansion valve 116 may be selectively operated according to a control signal of a full auto air condition temperature controller (FATC) 160.

The FATC 160 may control so that the compressor 117 is stopped or operated.

The controller 10 includes the FATC 160, an electric power control unit (EPCU) 127, and a battery management control unit (BMCU) 170 which are connected using CAN communication each other.

The EPCU 127 controls the operation of the cooling fan 123, and the BMCU 170 detects the temperature of the battery module 130.

The FATC 160 selectively operates the second expansion valve 116 by a signal, which is outputted from the BMCU 170, for requiring operation of the second expansion valve 116.

In addition, the EPCU 127 may control so that the first water pump 137 is stopped or operated.

The BMCU 170 may control so that the second water pump 137 is stopped or operated.

Thus, the control method of the battery cooling system configured as above according to various embodiments of the present invention can selectively use a refrigerant circulating in the air conditioner 110 in the electric vehicle or the hybrid vehicle to cool down the battery module 130 in a water-cool manner such that the system can be simplified, and the battery can be effectively managed thereby increasing a total travel distance of the vehicle.

Further, as the controller 10 controls an operation of the second expansion valve 116 which is connected to the chiller 135 when the battery module 130 needs to be cooled, cooling efficiency can be improved by further decreasing a temperature of the cooling water which is flowed into the battery module 130.

Further, through simplification of the entire system, manufacturing cost and weight can be reduced and spatial utilization can be improved.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control method for a battery cooling system of a vehicle which is provided for controlling temperature of a battery module by using a refrigerant supplied to a chiller in the battery cooling system, the battery cooling system including an air conditioner connected through a refrigerant line and a circulating refrigerant, an electric cooler connected with a cooling line and circulating a coolant, the battery module connected with the electric cooler through a battery cooling line, and the chiller supplying the coolant heat-exchanged with the refrigerant to the battery module, the method comprising:
(A) determining, by a controller, whether the air conditioner is operated, while driving or stopping the vehicle in a state where the vehicle is started;
(B) controlling, by the controller, a first expansion valve, and detecting, by the controller, the temperature of the battery module when the controller determines that the air conditioner is operated; and
(C) determining, by the controller, selective operation of a second expansion valve through determining whether the temperature of the battery module, which is detected through the controlling in (B), is within a predetermined range.

2. The method of claim 1, wherein the determining in (A) includes:
driving or stopping the vehicle in a state where the vehicle is started; and
determining, by the controller, whether the air conditioner is operated.

3. The method of claim 1, wherein the controlling in (B) includes operating, by the controller, the first expansion valve when the controller determines that the air conditioner is operated through the determining in (A);
operating, by the controller, a cooling fan and a compressor in a state that the first expansion valve is operated; and
detecting, by the controller, the temperature of the battery module.

4. The method of claim 3, further comprising detecting, by the controller, the temperature of the battery module when the controller determines that the air conditioner is not operated, in the determining in (A).

5. The method of claim 1, wherein the determining in (C) includes:
determining, by the controller, whether the temperature of the battery module, which is detected through the controlling in (B), is within predetermined set values; and
operating, by the controller, the second expansion valve to inflow the expanded refrigerant to the chiller when the controller determines that the temperature of the battery module is not within the predetermined set values.

6. The method of claim 1, wherein the second expansion valve is disposed on a first connection line which connects the chiller and the refrigerant line.

7. The method of claim 1, wherein the chiller is connected to the battery cooling line through a second connection line.

8. The method of claim 1, wherein the first expansion valve and the second expansion valve are selectively operated according to a control signal of a full auto air condition temperature controller (FATC).

9. The method of claim 8, wherein the controller comprises the FATC, an electric power control unit (EPCU), and a battery management control unit (BMCU) which are connected using Controller Area Network (CAN) communication with each other, and wherein
the EPCU controls an operation of a cooling fan;
the BMCU detects the temperature of the battery module; and
the FATC selectively operates the second expansion valve by a signal, which is output from the BMCU, for requiring operation of the second expansion valve.

10. The method of claim 9, wherein the electric cooler includes an electric radiator and a first water pump connected with a cooling line, and circulating cooling water to cool a motor, the EPCU, and an on board charger.

11. The method of claim 10, wherein a second water pump is disposed on the battery cooling line between the battery module and the chiller, and is operated by the BMCU.

12. The method of claim 11, wherein the determining in (C) includes operating, by the controller, the second water pump after the operating, by the controller, of the second expansion valve.

13. The method of claim 12, wherein the battery cooling line comprises:
a first valve connecting the cooling line that connects the motor and the electric device, and the battery cooling line; and
a second valve connecting the cooling line, the battery cooling line, and the second connection line.

14. The method of claim 13, wherein the second valve closes the cooling line and connects the battery cooling line and the second connection line when cooling the battery module using a refrigerant.
